(19) United States
(12) Patent Application Publication
(10) Pub. No.: US 2026/0010972 A1
(43) Pub. Date: Jan. 8, 2026

(54) SYSTEM AND METHOD FOR IMAGE ADJUSTMENT

(71) Applicant: Samsung Display Co., Ltd., Yongin-si, Gyeonggi-do (KR)

(72) Inventor: Harshad KADU, San Jose, CA (US)

(21) Appl. No.: 18/938,234

(22) Filed: Nov. 5, 2024

Related U.S. Application Data
(60) Provisional application No. 63/668,734, filed on Jul. 8, 2024.

(51) Int. Cl. G06T 3/40; G06T 9/00

(52) U.S. Cl. CPC G06T 3/40; G06T 9/00

(57) ABSTRACT

A system and method for image adjustment. In some embodiments, a method includes upsampling a first image to form an upsampled image and adjusting the upsampled image, based on a set of parameters, to form an output image. The set of parameters may have a total size, in bits, smaller than a total size of the upsampled image.

### CROSS-REFERENCE TO RELATED APPLICATION

This application claims the priority benefit under 35 U.S.C. § 119(e) of U.S. Provisional Application No. 63/668,734, filed on Jul. 8, 2024, the disclosure of which is incorporated by reference in its entirety as if fully set forth herein.

### TECHNICAL FIELD

The disclosure generally relates to image processing. More particularly, the subject matter disclosed herein relates to improvements to a system and method for image adjustment.

### SUMMARY

Displays, such as video displays used, for example, as computer monitors, may have unit-to-unit variations in a display panel imperfection referred to as mura, which may manifest itself as a non-uniform display intensity when the drive signal sent to the display panel is uniform.

To solve this problem, a mura correction array, which may be referred to as a mura compensation image, may be stored in the display, in a downsampled encoded form, and used, in operation, to correct for mura.

One issue with the above approach is that downsampling and upsampling (and, in some cases to a lesser extent, encoding and decoding of the mura compensation image) result in distortion of the mura compensation image that degrades display performance.

To overcome these issues, systems and methods are described herein for improving the fidelity of a mura compensation image.

The above approaches improve on previous methods because they may result in more accurate mura compensation, and better display performance.

According to an embodiment of the present disclosure, there is provided a method, including: upsampling a first image to form an upsampled image; and adjusting the upsampled image, based on a set of parameters, to form an output image, the set of parameters having a total size, in bits, smaller than a total size of the upsampled image.

In some embodiments, the method further includes decoding a second image to form the first image.

In some embodiments, the adjusting includes calculating a value of a first subpixel of the output image as a polynomial of values of a set of subpixels of the upsampled image, the polynomial having coefficients based on the parameters.

In some embodiments, the subpixels of the upsampled image are subpixels of a neighborhood of the first subpixel.

In some embodiments, the neighborhood is a square neighborhood centered on the first subpixel.

In some embodiments, the square neighborhood has dimensions of 3×3 or 5×5 or 7×7.

In some embodiments, the polynomial is a constant plus a weighted sum of the values of the set of subpixels.

In some embodiments, the weighted sum has weights based on the parameters.

In some embodiments, the output image is an image of mura compensation values.

In some embodiments, the method further includes: determining a mura image; downsampling the mura image to form a third image; upsampling a fourth image, the fourth image being based on the third image; calculating a discrepancy between the fourth image and the mura image; and calculating the parameters based on the discrepancy.

In some embodiments, the calculating of the parameters includes solving a least squares optimization.

In some embodiments, the method further includes: encoding the third image to form a fifth image; and decoding the fifth image to form the fourth image.

According to an embodiment of the present disclosure, there is provided a system, including: a processing circuit; and a memory connected to the processing circuit, the memory storing instructions that, when executed by the processing circuit, cause the processing circuit to perform a method, the method including: upsampling a first image to form an upsampled image; and adjusting the upsampled image, based on a set of parameters, to form an output image, the set of parameters having a total size, in bits, smaller than a total size of the upsampled image.

In some embodiments, the method further includes decoding a second image to form the first image.

In some embodiments, the adjusting includes calculating a value of a first subpixel of the output image as a polynomial of values of a set of subpixels of the upsampled image, the polynomial having coefficients based on the parameters.

In some embodiments, the subpixels of the upsampled image are subpixels of a neighborhood of the first subpixel.

In some embodiments, the neighborhood is a square neighborhood centered on the first subpixel.

In some embodiments, the square neighborhood has dimensions of 3×3 or 5×5 or 7×7.

In some embodiments, the polynomial is a constant plus a weighted sum of the values of the set of subpixels.

According to an embodiment of the present disclosure, there is provided a system, including: a display panel; a processing circuit, the processing circuit being configured to: upsample a first image to form an upsampled image; and adjust the upsampled image, based on a set of parameters, to form an output image, the set of parameters having a total size, in bits, smaller than a total size of the upsampled image.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a display device, according to an embodiment.

FIG. 2A is a block diagram of a process for handling a mura compensation image, according to an embodiment.

FIG. 2B is a block diagram of a process for handling a mura compensation image, according to an embodiment.

FIG. 3A is a block diagram of a process for handling a mura compensation image, according to an embodiment.

FIG. 3B is a block diagram of a process for handling a mura compensation image, according to an embodiment.

FIG. 4 is a subpixel layout diagram, according to an embodiment.

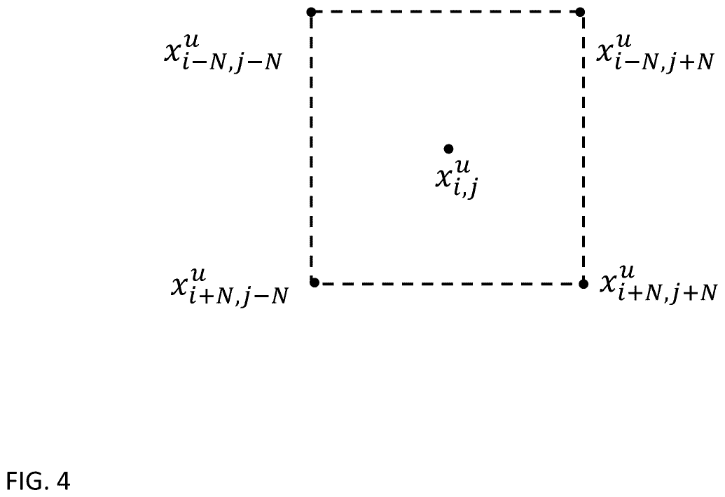

FIG. 5 is a table showing performance improvements, according to an embodiment.

FIG. 6 is a flowchart, according to an embodiment.

FIG. 7 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “predetermined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

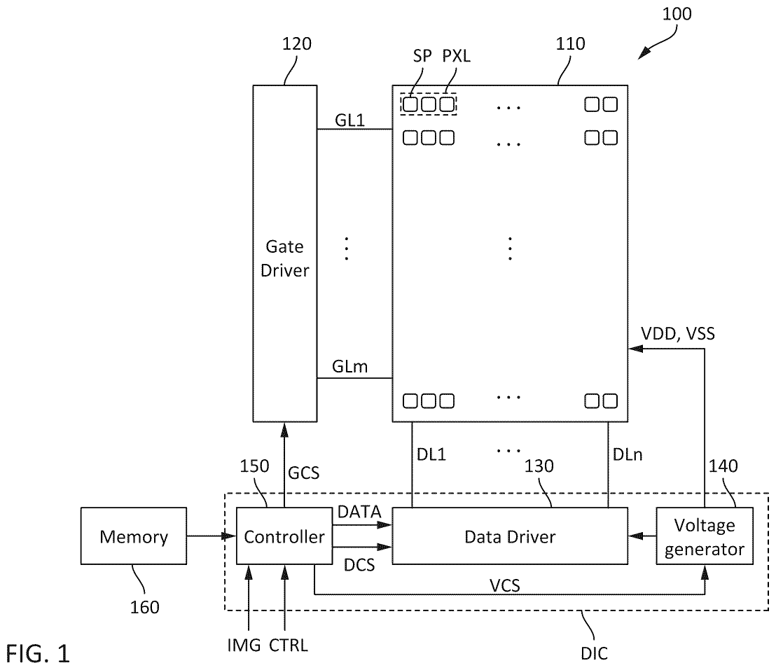

FIG. 1 is a block diagram of a display device according to some embodiments. Referring to FIG. 1, a display device 100 may include a display panel 110, a gate driver 120, a data driver 130, a voltage generator 140, and a controller (or “display controller”) 150.

The display panel 110 includes subpixels SP. The subpixels SP may be connected to the gate driver 120 through first to m-th gate lines GL1 to GLm. The subpixels SP may be connected to the data driver 130 through first to n-th data lines DL1 to DLn.

Each of the subpixels SP may include at least one light emitting element configured to generate light. Accordingly, the subpixels SP may respectively generate light of a specific color, such as red, green, blue, cyan, magenta, yellow, or the like. Two or more of the subpixels SP may form one pixel PXL. For example, as shown in FIG. 1, three subpixels may form one pixel PXL.

The gate driver 120 is connected to the subpixels SP arranged in a row direction through the first to m-th gate lines GL1 to GLm. The gate driver 120 may output gate signals to the first to m-th gate lines GL1 to GLm in response to a gate control signal GCS. According to some embodiments, the gate control signal GCS may include a start signal indicating the start of each frame, a horizontal synchronization signal for outputting gate signals in synchronization with the timing at which data signals are applied, and the like.

The gate driver 120 may be located on one side of the display panel 110. However, embodiments are not limited thereto. For example, the gate driver 120 may be divided into two or more physically and/or logically separated drivers, and the drivers may be located on one side of the display panel 110 and the other side of the display panel 110 opposite to the one side. As described above, the gate driver 120 may be arranged around the display panel 110 in various forms according to the embodiments.

The data driver 130 is connected to the subpixels SP arranged in a column direction through the first to n-th data lines DL1 to DLn. The data driver 130 receives image data (DATA) and data control signal DCS from the controller 150. The data driver 130 operates in response to the data control signal DCS. According to some embodiments, the data control signal DCS may include a source start pulse, a source shift clock, a source output enable signal, and the like.

The data driver 130 may use voltages from the voltage generator 140 to apply data signals having grayscale voltages corresponding to the image data (DATA) to the first to n-th data lines DL1 to DLn. When a gate signal is applied to each of the first to m-th gate lines GL1 to GLn, data signals corresponding to the image data DATA may be applied to the data lines DL1 to DLm. Accordingly, the corresponding subpixels SP may generate light corresponding to the data signals. Accordingly, images may be displayed on the display panel 110.

According to some embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 is configured to generate a plurality of voltages and provide the generated voltages to constituent elements of the display device 100. For example, the voltage generator 140 may be configured to generate a plurality of voltages by receiving an input voltage from the outside of the display device 100, adjusting the received voltage, and regulating the adjusted voltage.

The voltage generator 140 may generate a first power voltage VDD and a second power voltage VSS, and the generated first and second power voltages VDD and VSS may be provided to the subpixels SP. The first power voltage VDD may have a relatively high voltage level, and the second power voltage VSS may have a voltage level lower than the first power voltage VDD. According to some embodiments, the first power voltage VDD or the second power voltage VSS may be provided by an external device of the display device 100.

In addition, the voltage generator 140 may generate various voltages. For example, the voltage generator 140 may generate an initialization voltage applied to the subpixels SP. For example, during a sensing operation to sense electrical characteristics of transistors and/or light emitting elements of the subpixels SP, a reference voltage (e.g., a set or predetermined reference voltage) may be applied to the first to n-th data lines DL1 to DLn, and the voltage generator 140 may generate the reference voltage.

The controller 150 controls various operations of the display device 100. The controller 150 receives input image data IMG and a control signal CTRL for controlling the display of the input image data, from the outside. The controller 150 may provide the gate control signal GCS, the data control signal DCS, and the voltage control signal VCS in response to the control signal CTRL.

The controller 150 may convert the input image data IMG to be suitable for the display device 100 or the display panel 110 to output the image data DATA. According to some embodiments, the controller 150 may output the image data DATA by aligning the input image data IMG to be suitable for the arrangement of the subpixels SP.

Two or more components of the data driver 130, the voltage generator 140, and the controller 150 may be mounted on one integrated circuit. As shown in FIG. 1, the data driver 130, the voltage generator 140, and the controller 150 may be included in a driver integrated circuit DIC. In this case, the data driver 130, the voltage generator 140, and the controller 150 may be functionally separate components within one driver integrated circuit DIC. According to some embodiments, at least one of the data driver 130, the voltage generator 140, or the controller 150 may be provided as a component separated from the driver integrated circuit DIC.

According to some embodiments, the display device 100 may include at least one memory 160. The memory 160 may include (e.g., consist of) nonvolatile memory (as discussed in further detail below).

As mentioned above, FIG. 1 is a system-level block diagram of a display device 100, such as a television, a computer monitor, or a built-in display in a mobile device, such as a laptop computer, a tablet computer, or a mobile telephone. The display includes a display panel 110 (which includes a plurality of pixels (e.g., a rectangular array of pixels)), of which each pixel may include a plurality of subpixels (e.g., a red subpixel, a green subpixel, and a blue subpixel). In a monochrome display panel (and in a monochrome display device), each pixel may include only one subpixel and the terms “pixel” and “subpixel” may be synonymous.

In part because of spatial variation across the display panel introduced during the manufacturing process for the display panel, the responsivity of the subpixels (e.g., the irradiance for a fixed control signal (e.g., for a fixed control voltage or for a fixed drive voltage) may not be uniform across the display. This nonuniformity may be referred to as mura, and if not corrected it may degrade the performance of the display, e.g., the mura may produce visual artifacts perceptible to a user.

As such, mura may be measured during the manufacturing process and mura compensation may be used to reduce mura. Mura compensation may refer to the process of removing non-uniform brightness or chromaticity in the display panel of a display. The mura values used for compensation are mapped to an image, which may be referred to as mura compensation image, and stored in the display device.

The mura compensation image may include, for example, a multiplicative correction factor for each subpixel. In operation, the value received, for a subpixel, from the circuit driving the display device (e.g., from a video card) may be multiplied by the value of the corresponding subpixel of the mura compensation image before being converted to an analog signal used to control the subpixel in the display panel 110.

Mura compensation may be performed by a display controller 150 of the display device 100. The display controller 150 may read the mura compensation image from a display memory 160 of the display device 100, and the display controller 150 may apply the corrections of the mura compensation image in operation.

For example, the display controller 150 may receive an image to be displayed, in digital form, from a video card connected to the display device 100. The display controller 150 may then apply the value of each subpixel of the mura compensation image to the corresponding subpixel of the image received from the video card, to correct the subpixel value, before sending the corrected subpixel value to a digital to analog converter for generating an analog drive signal for the subpixel.

The correcting of the subpixel may involve, as mentioned above, multiplying the received subpixel value by the value of the corresponding subpixel in the mura compensation image. In other embodiments, a different correction may be applied, e.g., the correcting of the subpixel may involve adding the value of the corresponding subpixel in the mura compensation image to the received subpixel value.

The mura compensation image may be stored in nonvolatile memory of the display device 100, e.g., the display memory 160, or a portion of the display memory 160 used to store the mura compensation image, may be or include nonvolatile memory (e.g., it may be flash memory).

The use of nonvolatile memory may make it possible for the mura compensation image to be preserved when power to the display device 100 is interrupted or when the display device 100 is shut off. Nonvolatile memory may be relatively costly, however. As such, the size of the mura compensation image may be reduced before it is stored in the display device 100.

For example, the mura compensation image may be downsampled before being stored in the display device 100. This downsampling may involve, for example, averaging (e.g., replacing a plurality of subpixels with a single subpixel having a value equal to the average of the values of the subpixels being replaced) or the use of a spline, or a filter, or of the use of Lanczos resampling.

Further, the mura compensation image may be encoded, using an image compression algorithm, after downsampling. The downsampled encoded mura compensation image may then be stored in the display device 100 (e.g., in nonvolatile memory of the display device 100).

In operation, the downsampled encoded mura compensation image may be read from the nonvolatile memory of the display device 100 by the display controller 150, decoded, upsampled, and used to drive the display panel 110 (e.g., via a digital to analog converter).

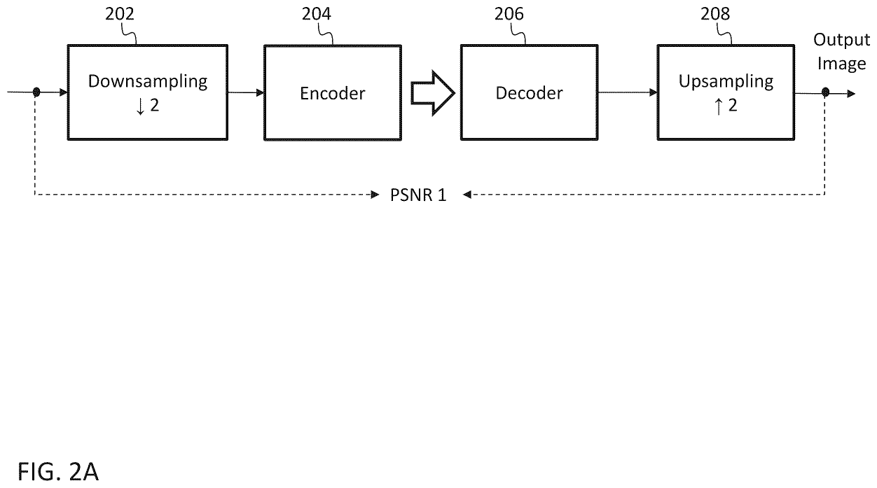

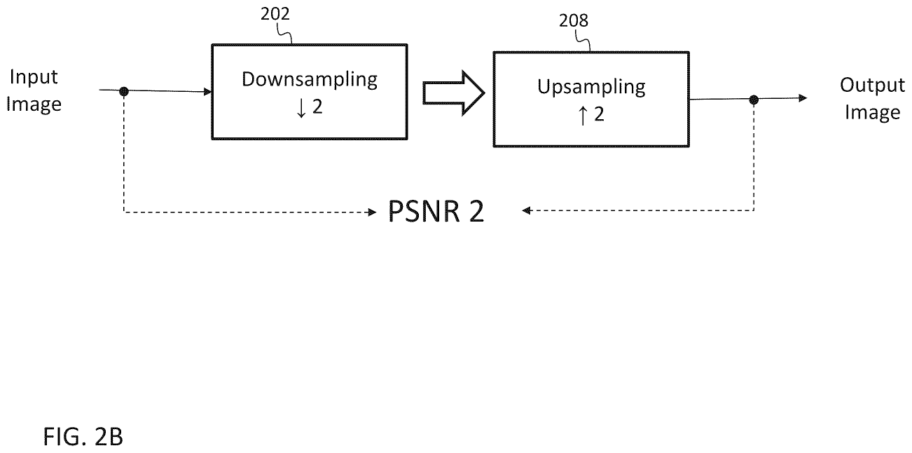

This process is illustrated in FIG. 2A, The process involves generating a mura compensation image (in the manufacturing facility), downsampling, at 202, the mura compensation image (in the manufacturing facility), encoding, at 204, the mura compensation image (in the manufacturing facility), decoding the mura compensation image, at 206, in the display device 100, and upsampling, at 208, the mura compensation image, in the display device 100.

As mentioned above, the mura compensation image may be downsampled, compressed (e.g. encoded) and stored in the device as a bitstream during the manufacturing process. The display device 100 may then decompress (e.g., decode) this bitstream, and upsample the reconstructed image to obtain the upsampled mura compensation image. The upsampled mura compensation image is then used to compensate for mura defects.

The downsampling and upsampling process may introduce significant distortion, e.g., the upsampled mura compensation image may deviate from the original mura compensation image. This deviation may lead to substandard mura compensation performance.

As such, in some embodiments, an upsampling refinement process (or “adjustment” process) that maps the upsampled parameter image to a refined mura compensation image is used. The refined (or “adjusted”) mura compensation image may be closer to the original mura compensation image than an upsampled mura compensation image not using the adjustment process.

The adjustment process may be based on a polynomial function. For example, (as discussed in further detail below), the polynomial function may be a first-order polynomial function.

The adjustment function may be a function that maps an upsampled image into an adjusted upsampled image, in a manner that improves the agreement between (e.g., reduces the discrepancy between) the original mura compensation image and the adjusted mura compensation image.

The adjustment function may use spatial information around a given subpixel to calculate the adjustment for that subpixel. The coefficients of the polynomial function may be computed at the encoder (e.g., in the manufacturing facility, after mura has been measured) and stored in the bitstream.

The encoding may be performed only once, in software, for the mura compensation image. As such, the increase in computational processing at the encoder may be acceptable.

There may be only one set of parameters (e.g., polynomial coefficients) used to perform the adjustment for the entire mura compensation image, so that the storage space required to store these parameters may be insignificant compared to the size of the compressed bitstream.

The decoder may use these coefficients directly to compute the adjustment for the given subpixel with a small number of multiplication and addition operations. The peak signal-to-noise ratio (PSNR) performance improvement is significant with minor increase in the compute at the decoder.

As shown in FIG. 2A, the value of PSNR1 is the peak-signal-to-noise ratio of an input mura compensation image that is downsampled, compressed, decompressed and upsampled to produce the output mura compensation image.

FIG. 2B shows an alternate process that excludes the steps of encoding and decoding. As shown in FIG. 2B, PSNR2 is the peak-signal-to-noise ratio of an input mura compensation image that is downsampled and upsampled to produce the output mura compensation image. For mura compression algorithm (MCA) images, the value of PSNR2 may be below 40 dB without the loss introduced by compression.

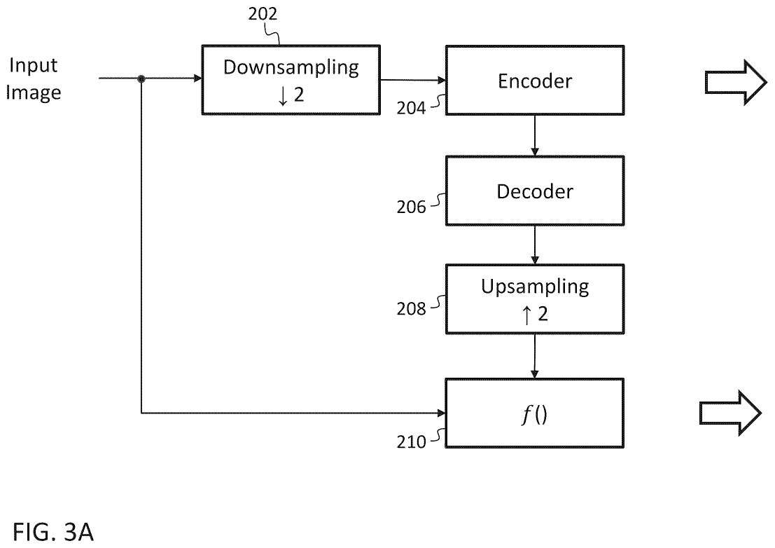

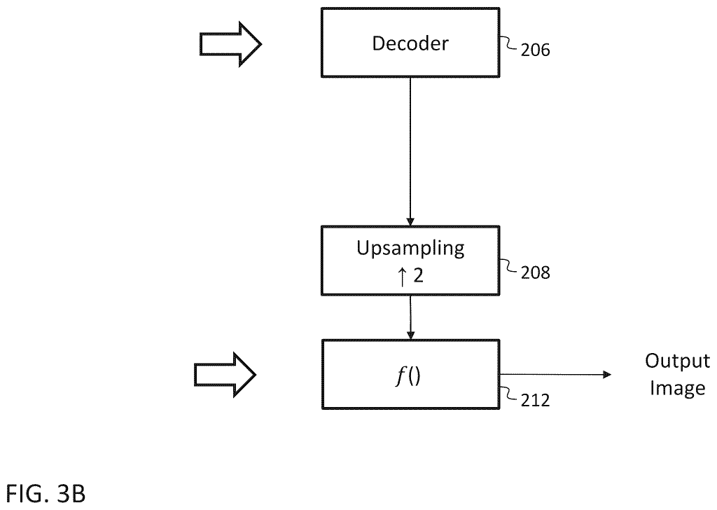

FIGS. 3A and 3B shows a process including adjustment of the mura compensation image by an adjustment function f( ). The adjustment function may be used to map a mura compensation image (e.g., a mura compensation image that results from decoding and upsampling of a downsampled and encoded original mura compensation image) to an adjusted mura compensation image (which may, as a result of the adjustment, differ less from the original mura compensation image).

FIG. 3A shows a process that may be performed in the manufacturing facility. The process includes generating a mura compensation image, downsampling, at 202, the mura compensation image, encoding, at 204, the mura compensation image, decoding, at 206, the mura compensation image, and upsampling, at 208, the mura compensation image. The process further includes a parameter determination operation 210 (discussed in further detail below). The results of the encoding 204 (which may be referred to as the downsampled encoded mura compensation image) and the results of the parameter determination operation 210 (which may be referred to as the adjustment parameters, or as the set of parameters) may be stored in the display memory 160 (e.g., in nonvolatile memory) of the display device 100.

FIG. 3B shows a process for reconstructing a mura compensation image, in some embodiments. The process of FIG. 3B may be performed in the display device 100, e.g., by the display controller 150 of the display device 100, based on the downsampled encoded mura compensation image stored in the display memory 160 of the display device 100 and based on the adjustment parameters stored in the display memory 160 of the display device 100. The process of FIG. 3B includes decoding, at 206, the downsampled encoded mura compensation image, and upsampling, at 208, the resulting mura compensation image. The process further includes adjusting, at 212, the mura compensation image, based on the adjustment parameters, in a manner discussed in further detail below.

As illustrated in FIGS. 3A and 3B, a polynomial function ƒ( ) may be trained at the encoder side (at the manufacturing facility) (e.g., the adjustment parameters may be determined using a parameter determination operation 210) and the parameters may be provided to the decoder (e.g., by storing the parameters in the display memory 160 (e.g., in nonvolatile memory) of the display device 100).

A separate function may be trained for each channel (e.g., for each array of subpixels, such as the red subpixels, the green subpixels, and the blue subpixels). These functions may be referred to as ƒₓ( ), where x may be r, g, or b, for the red, green or blue channels respectively.

This function may estimate the subpixel values in the output image

$$( {r}_{i , j}^{o} , {g}_{i , j}^{o} , {b}_{i , j}^{o} )$$

based on a 3×3, 5×5 or 7×7 neighborhood of the upsampled image around

$$( {r}_{i , j}^{u} , {g}_{i , j}^{u} , {b}_{i , j}^{u} ) .$$

The value of each subpixel in the adjusted mura compensation image may be given by

$${x}_{i , j}^{o} = {C}_{0} + {C}_{1} {x}_{i - N , j - N}^{u} + {C}_{2} {x}_{i - N , j - N + 1}^{u} ⋯ + {C}_{( N + 1 ) * ( N + 1 )} {x}_{i + N , j + N}^{u} \qquad ( 1 )$$

The adjustment parameters may be the coefficients C₀ to C_{(2N+1)*(2N+1)}, which may be determined (or “trained”) for each channel separately. In a display with three channels, a total of 3*(2N+1)*(2N+1)+3 coefficients may be sent to the decoder (e.g., stored in the display memory 160 (e.g., in nonvolatile memory) of the display device 100), for the entire mura compensation image.

This data volume may be small, e.g., the total size of the set of parameters may be smaller than the total size of the upsampled image (or, in some embodiments, less than the size of the downsampled encoded mura compensation image), or smaller than the total size of the compressed bitstream (which may be the same as the total size of the downsampled encoded mura compensation image).

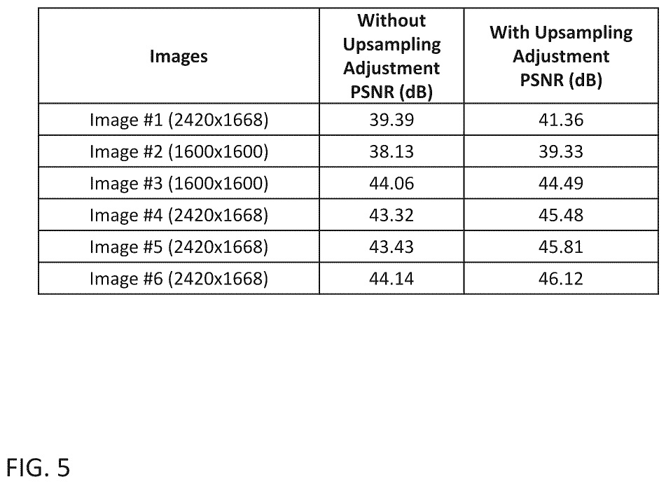

For example, an input image of size 1920×1080 downsampled by 2 and compressed to 8:1 may use 1555200 bits. The upsampling refinement coefficients for 5×5 block represented using 32 bits each take 2496 bits. As such, the storage space required to store the adjustment parameters is only 0.16% of the storage space to store the downsampled encoded mura compensation image. As the image size increases or the compression ratio is 2:1 or 4:1, the fraction of bits used to represent the coefficients may be even lower. The table of FIG. 5 shows the improvement achievable, for various image sizes.

Some embodiments improve the technology of displaying images using video displays, or, in computer systems including displays, the operation of the computer itself. Although examples herein are explained in the context of a mura compensation image, this disclosure is not limited to such embodiments and the systems and methods disclosed herein may be used with any image.

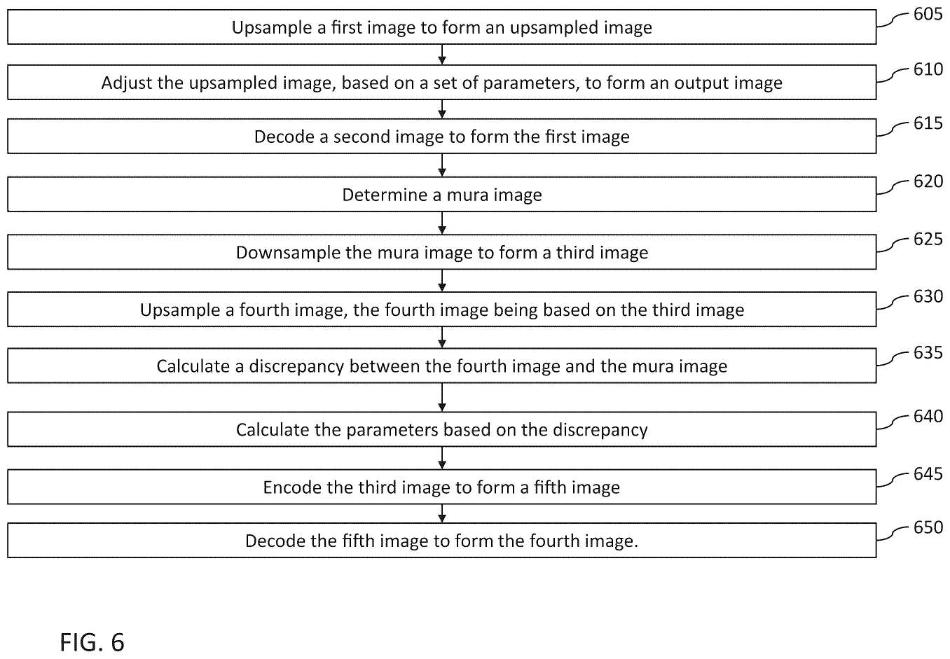

FIG. 6 shows a method of image adjustment, in some embodiments. Although FIG. 6 illustrates various operations in such a method, embodiments according to the present disclosure are not limited thereto. For example, according to some embodiments, such a method may include additional operations or fewer operations, or the order of operations may vary (unless otherwise explicitly stated or implied).

The method of FIG. 6 includes upsampling, at 605, a first image to form an upsampled image. For example, the display controller 150 may read the downsampled encoded mura compensation image from the display memory 160, decode it to form the first image, and upsample the first image to form an upsampled image. The method further includes adjusting, at 610, the upsampled image, based on a set of parameters, to form an output image. For example, as discussed above, the display controller 150 may read the adjustment parameters (which may be the coefficients of Equation 1) from the display memory 160, and calculate the output image (the adjusted mura compensation image) using Equation 1. The set of parameters may have a total size, in bits, smaller than a total size of the upsampled image. The method further includes decoding, at 615, a second image (e.g., the downsampled encoded mura compensation image, as mentioned above) to form the first image.

The adjusting may include calculating a value of a first subpixel of the output image as a polynomial of values of a set of subpixels of the upsampled image, the polynomial having coefficients based on (e.g., equal to) the parameters. The subpixels of the upsampled image may be subpixels of a neighborhood of the first subpixel. As used herein, a “neighborhood” of a first subpixel of a channel is a set of contiguous subpixels of the channel, the set of contiguous subpixels including the first subpixel.

The neighborhood may be a square neighborhood centered on the first subpixel, e.g., a square neighborhood having dimensions of 3×3 or 5×5 or 7×7, which may be centered on the subpixel. The polynomial may be a constant plus a weighted sum of the values of the set of subpixels. The weighted sum may have weights (e.g., the coefficients of Equation 1) based on (e.g., equal to) the parameters. The output image may be an image of mura compensation values. The method further includes determining a mura image, at 620. This determining may be performed, for example, in the manufacturing facility, and it may involve controlling the display panel 110 to display a flat image, in each channel, one at a time, while measuring with an imaging instrument (e.g., with a camera) the irradiance pattern generated. The method further includes downsampling the mura image, at 625, to form a third image, upsampling, at 630, a fourth image, the fourth image being based on the third image (e.g., the fourth image being equal to the third image or the fourth image being a image that results from encoding and decoding the third image), calculating, at 635, a discrepancy between the fourth image and the mura image; and calculating, at 640, the parameters based on the discrepancy. The calculating of the parameters comprises solving a least squares optimization based on the discrepancy. As mentioned above (in the context of step 630), the method may further include encoding, at 645, the third image to form a fifth image; and decoding, at 650, the fifth image to form the fourth image. As discussed above in the context of FIG. 3A, steps 620 through 650 may be performed, for example, in the manufacturing facility.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

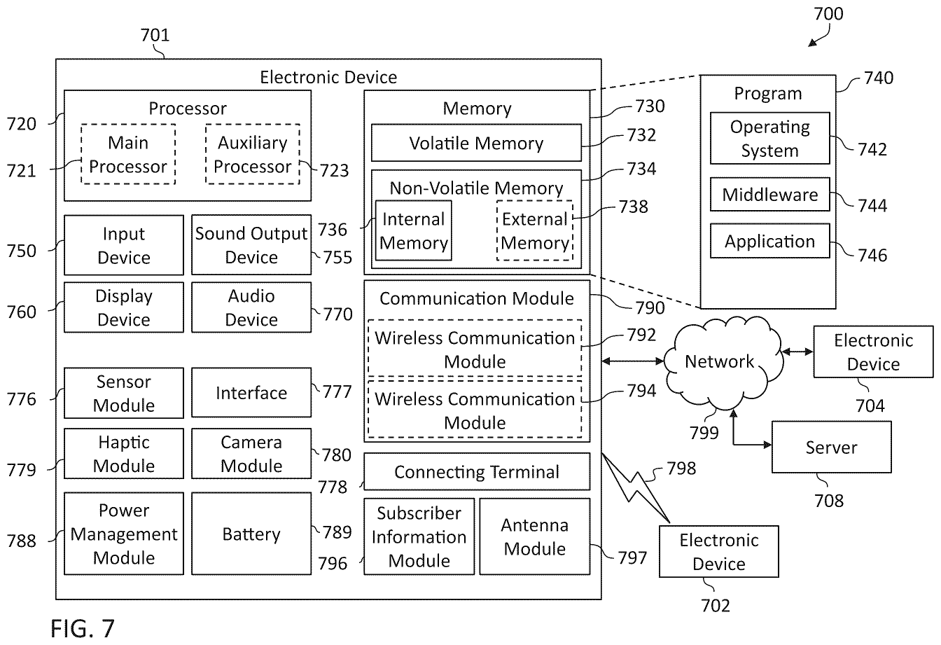

FIG. 7 is a block diagram of an electronic device in a network environment 700, according to an embodiment.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
upsampling a first image to form an upsampled image; and
adjusting the upsampled image, based on a set of parameters, to form an output image,
the set of parameters having a total size, in bits, smaller than a total size of the upsampled image.

2. The method of claim 1, further comprising decoding a second image to form the first image.

3. The method of claim 1, wherein the adjusting comprises calculating a value of a first subpixel of the output image as a polynomial of values of a set of subpixels of the upsampled image, the polynomial having coefficients based on the parameters.

4. The method of claim 3, wherein the subpixels of the upsampled image are subpixels of a neighborhood of the first subpixel.

5. The method of claim 4, wherein the neighborhood is a square neighborhood centered on the first subpixel.

6. The method of claim 5, wherein the square neighborhood has dimensions of 3×3 or 5×5 or 7×7.

7. The method of claim 4, wherein the polynomial is a constant plus a weighted sum of the values of the set of subpixels.

8. The method of claim 7, wherein the weighted sum has weights based on the parameters.

9. The method of claim 1, wherein the output image is an image of mura compensation values.

10. The method of claim 9, further comprising:
determining a mura image;
downsampling the mura image to form a third image;
upsampling a fourth image, the fourth image being based on the third image;
calculating a discrepancy between the fourth image and the mura image; and
calculating the parameters based on the discrepancy.

11. The method of claim 10, wherein the calculating of the parameters comprises solving a least squares optimization.

12. The method of claim 10, further comprising:
encoding the third image to form a fifth image; and
decoding the fifth image to form the fourth image.

13. A system, comprising:
a processing circuit; and
a memory connected to the processing circuit, the memory storing instructions that, when executed by the processing circuit, cause the processing circuit to perform a method, the method comprising:
upsampling a first image to form an upsampled image; and
adjusting the upsampled image, based on a set of parameters, to form an output image,
the set of parameters having a total size, in bits, smaller than a total size of the upsampled image.

14. The system of claim 13, wherein the method further comprises decoding a second image to form the first image.

15. The system of claim 13, wherein the adjusting comprises calculating a value of a first subpixel of the output image as a polynomial of values of a set of subpixels of the upsampled image, the polynomial having coefficients based on the parameters.

16. The system of claim 15, wherein the subpixels of the upsampled image are subpixels of a neighborhood of the first subpixel.

17. The system of claim 16, wherein the neighborhood is a square neighborhood centered on the first subpixel.

18. The system of claim 17, wherein the square neighborhood has dimensions of 3×3 or 5×5 or 7×7.

19. The system of claim 16, wherein the polynomial is a constant plus a weighted sum of the values of the set of subpixels.

20. A system, comprising:
a display panel;
a processing circuit,
the processing circuit being configured to:
upsample a first image to form an upsampled image; and
adjust the upsampled image, based on a set of parameters, to form an output image,
the set of parameters having a total size, in bits, smaller than a total size of the upsampled image.
